(19) United States
(12) Patent Application Publication
(10) Pub. No.: US 2012/0210276 A1
(43) Pub. Date: Aug. 16, 2012

(54) SYSTEM AND METHOD TO STORE A SERVICE OR CONTENT LIST FOR EASY ACCESS ON A SECOND DISPLAY

(75) Inventors: Ling Jun Wong, Champaign, IL (US); Charles McCoy, Coronado, CA (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/233,398

(22) Filed: Sep. 15, 2011

Related U.S. Application Data
(60) Provisional application No. 61/442,030, filed on Feb. 11, 2011.

(51) Int. Cl. G06F 3/048

(52) U.S. Cl. 715/835

(57) ABSTRACT

Apparatus and methods are provided for using a second display with a content playback device. This feature allows the user to permanently store a service, menu location, or content list, e.g., a category of assets within a service, as a shortcut for easy access in the future. The shortcut could be accessed in a list of shortcuts or could be specifically added to a section on the main screen so that the user can navigate to the service, menu location, or content list from anywhere in a second display application in just a single click. The user can also name the shortcut so that the same may be found by search tools. Such systems and methods may be particularly advantageous when a user normally only visits a few services in a long list of available services on a regular basis.

### CROSS-REFERENCE TO RELATED APPLICATIONS

This application claims benefit of priority of U.S. Provisional Patent Application Ser. No. 61/442,030, filed Feb. 11, 2011, entitled “METHOD TO STORE A SERVICE OR CONTENT LIST AS A SHORTCUT FOR EASY ACCESS ON A SECOND DISPLAY”, owned by the assignee of the present application and herein incorporated by reference in its entirety.

### BACKGROUND

Internet delivery of digital content to IPTVs continues to increase, as does the popularity of IPTVs themselves. Digital content delivery is generally performed from content service providers. When a user browses such content service providers, the user normally only has a few services which they will regularly use. But if a service is desired to be accessed multiple times, the user is generally required to navigate to the service, find a desired asset, and commence playback each time. For often-accessed services, this often becomes inconvenient. The same is generally true of content lists or various other locations within infrastructures. While convenient to have, if the same are difficult to navigate to, as is currently prevalent, the difficulty in access often outweighs the benefits.

### SUMMARY

Systems and methods are provided that allow a user to permanently store a service as a shortcut for easy access in the future. The short may could be accessed in a list of service shortcuts or may be specifically added to a section on the main screen so that the user can go to the service from anywhere in the application in just a single click. The user may also name the shortcut so that it may be found by a global search tool provided in the application for searching. This feature is desirable and provides the user a better user experience in browsing services.

Steps of the method may include the following. For the case of adding a service as a shortcut: the user first loads the second display application and selects a service. In the option menu for that service, the user can select the service to be added as a shortcut. A dialog box may pop up and request confirmation and the name of the shortcut. Upon successful confirmation, the shortcut will be created and may be retrieved in the shortcuts list or from the search results in a global search tool. For the case of adding a content list as a shortcut, the user again loads the second display application and selects a service. The user enters a service and is returned a content list. Generally, during the entire browsing experience in that service, different content lists will be returned at different times. In an option menu for that service, the user may select the current content list to be added as a shortcut. As before, a dialog box may pop up and request confirmation and the name of the shortcut. Upon successful confirmation, the shortcut may be created and may be retrieved in the shortcuts list or from the search results in the global search tool.

On the backend, information like category identification and service identification of the content list may be stored for future retrieval. A clean up tool may be employed to ensure the content list still exists, as service providers may remove it, or individual assets or other items within it, at any time. In this regard it is noted that the service ID may not change, however the URL associated with a given asset URL may expire in a certain time frame due to the content item being classified as a rental or having other content time restrictions placed thereon.

Variations of the system and method will be seen. For example, the term content list can refer to a category list or any other sort of list of assets or content items, whether created by the user or created by the system, either automatically or on the basis of some user-specified criterion. The shortcut may be stored as a widget, as an icon, or as any other type of activatable feature. The shortcut as noted above can relate to a category, such as horror films, but the category could also span different services, pulling in content items from multiple different sources. Such shortcuts are referred to here as cross-service content item shortcuts, even if their included items include services as well as assets. The list of content items may also include entries that are menu locations, such as utilities or administrative functions, within the second display or within the management server ecosystem. For example, a search performed that finds a particular content item may also find a utility or administrative function, so long as the search criterion is still met. This feature may be particularly important when an often-accessed menu item resides several levels deep in a menu structure, e.g., parental ratings or the like. Shortcuts are generally specific to a given device, such as to a given second display. However, in certain implementations, shortcuts may be ported to another device or shared, e.g., from device to device or through the network. The presence of shortcuts may be in part dependent on the screen real estate of the second display. For example, a smart phone has a more limited screen then a laptop. However, due to the difficulty of navigating several levels deep on a smart phone, shortcuts may be particularly important to have on such a mobile device.

The second display provides complementary functionality to the IPTV, and generally does not require additional investment by the user because the same makes use of a device, e.g., a smartphone, laptop computer, tablet computer, an internet appliance, etc., which most users would already have in their possession. Such a second display provides a complementary functionality to a content playback device such as an IPTV because of the second display's strength in supported languages and character font sets, data entry, processing power, and user experience in content management.

Where the second display application is a web application, the same may be scripting or non-scripting. The second display application may also be a Java application or any other sort of application that may communicate with a server. For example, the ASP/.NET framework with RPC can be employed to write the second display application. Where the web application running on the second display is written in HTML or HTML with Javascript, the same may be loaded by any device with a browser, and so the same is not limited to only a small set of compatible devices or expensive remote controls. Where a smartphone is employed, a mobile version of the second display user interface may be employed, with an appropriate listing of fields and an appropriate mobile resolution.

Communications with service providers may take place through a proxy server, and the proxy server presents to service providers the authentication credentials of the content playback device, so that the second displays appear to the service providers as authenticated content playback devices.

As noted above, the second displays may include any device that can run an application that communicates with a content playback device, including, but not limited to, personal computers, laptop computers, notebook computers, netbook computers, handheld computers, personal digital assistants, mobile phones, smart phones, tablet computers, hand-held gaming devices, gaming consoles, Internet appliances, and also on devices specifically designed for these purposes, in which case the special device would include at least a processor and sufficient resources and networking capabilities to run the second display application.

The content playback device can take many forms, and multiple content playback devices can be coupled to and selected within a given local network. Exemplary content playback devices may include IPTVs, DTVs, digital audio systems, or more traditional video and audio systems that have been appropriately configured for connectivity. In video systems, the content playback device includes a processor controlling a video display to render content thereon.

In a general method, a user employing a second display has a user account with a source or clearinghouse of services. Here, the source or clearinghouse is represented as a user account on a management server, but it should be understood that the user account may be with a service provider directly. The user account may have information stored thereon related to what content playback devices are associated with the user account. When a user logs on, they may see this list of content playback devices and may choose a particular content playback device. If there is only one content playback device on the network, or if the user is browsing in a way that the content playback device identity is not needed, then this step may be omitted. Moreover, a user may control content playback devices that are not included in a user account. For example, content playback devices may be discoverable and controllable, e.g., via infrared or Bluetooth® or otherwise, that are not part of the user account with a management server or with a service provider. It may even be possible for a user to play back content on such a content playback device, if a service provider has made available content that can be delivered without access made to a user account.

Where no content playback device has been selected, all available content may be displayed. If no content playback device has been selected, but the user account includes stored information about which content playback devices are available, then all content may be displayed, a subset of all content may be displayed based on the known content playback devices associated with the account, or notations may be presented about which content playback devices can play which content, or a combination of these. In some cases, a content service provider may require a content playback device to be chosen so as to determine if content from that service provider may be played back. In other cases, no content playback device need be chosen and the user may simply choose and queue content for later playback by a content playback device to-be-determined at a later time.

Assuming multiple services are available, the user then selects a service to browse. In many cases, access to a service requires becoming affiliated with the service. Details of such affiliation processes are provided in U.S. patent application Ser. No. 12/982,463, filed Dec. 30, 2010, entitled “Device Registration Process from Second Display”, owned by the assignee of the present application and incorporated by reference herein. Once the content playback device is affiliated with services, the user may choose which service they wish to browse. Where a content playback device has not been chosen, the user may still choose services and browse, but the content offerings may be less specific to a given content playback device. The service presents a list of available assets. The presentation may be in any number of forms, including by category, by keyword, or in any other form of organization. The proxy server presents an authentication credential of the content playback device to the content server. In some cases, credentials for accessing the various services may be stored in the user account, and presented by the proxy server or management server to the content server when needed.

Individual services may employ their own DRM schemes which the current systems and methods may then incorporate. For example, if a video content service provider only allows a predetermined number of devices on which their content may be played back, then this rule may be enforced or duplicated within the context of the current system and method. Moreover, changes to such service provider rules or other parameters may be periodically polled for by the proxy server and/or management server, or the same may be polled for at a subsequent login of the service, e.g., at the time the affiliation is renewed. In other words, upon login, the system and method may poll for and receive a token associated with the given service provider, the token providing information to the system about the service provider as well as about the user account with the service provider.

The system and method may include a management server as mentioned above which, along with the content playback device, communicates with at least one content server such that the content server provides assets for presentation at the content playback device. The system and method may further include a proxy server communicating with the management server and the second displays. In some cases, the proxy server may be merged with the management server, or in other cases a separate proxy server may be provided for each content server or service provider.

In one aspect, the invention is directed to a method of creating a shortcut to a service or content list, including: in a second display application, receiving a user input to establish a session with a server, the session associated with a user account; receiving a user selection of a service, a menu location, or a content list; and receiving a user selection of the service, menu location, or content list, respectively, as a shortcut, such that upon a loading of the second display application, the shortcut appears within the application.

Implementations of the invention may include one or more of the following. The method may further include creating a shortcut within the second display application to the selected service, menu location, or content list. The second display application may be a web application. The content list may be a category within a service. The shortcut may appear as a widget or icon or activatable feature on a page of the second display application. The shortcut may appear in a list of shortcuts. The shortcut may be associated with a shortcut name, and the name of the shortcut may be discoverable in a search field within the second display application. The user selection may be of a content list, and the method may further include storing a category identification or service identification of the content list. The user selection may be of a content list, and the method may further include updating the content list, to remove content items that point to content that is no longer available. The user selection may be of a content list, and the content list may be determined by a service or by a user. The user selection may be of a menu location, and the menu location may correspond to a utility or administrative function. The receiving a user selection of a service, a menu location, or a content list, may include receiving search results from a search function within the second display application, and the search results may include services, menu locations, content items, or content lists. The method may further include creating a copy of the shortcut on another computing device.

In another aspect, the invention is directed towards a non-transitory computer-readable medium, comprising instructions for causing a computing device to perform the above method.

In another aspect, the invention is directed towards a method of creating a shortcut to a service or content list, including: in a second display application, receiving user input to establish a session with a server, the session associated with a user account; receiving a user selection of a service, a menu location, or a content list; and receiving user selection of the service, menu location, or content list, respectively, as an item to be added to a cross-service content list, the cross-service content list associated with a shortcut, such that upon the loading of the second display application, the shortcut appears within the second display application.

In a further aspect, the invention is directed towards a method of creating a shortcut to a service or content list, including: receiving a user input from a second display application to establish a session, the session associated with a user account; receiving a user selection of a service, a menu location, or a content list; directing the second display application to the selected service, menu location, or content list, respectively; receiving a user selection of the service, menu location, or content list, respectively, as a shortcut; causing the shortcut to be stored; and causing the shortcut to be displayed within the second display application.

Implementations of the invention may include one or more of the following. The causing the shortcut to be stored may include causing the shortcut to be stored within the server or within the second display application. The user selection may be of a content list, and may further include storing a category identification or service identification corresponding to the content list. The user selection may be of a content list, and may further include updating the content list, to remove content items that point to content that is no longer available.

In another aspect, the invention is directed towards a non-transitory computer-readable medium, comprising instructions for causing a computing device to perform the above method.

In another aspect, the invention is directed towards a method of creating a shortcut to a service or content list, including: receiving user input from a second display application to establish a session, the session associated with a user account; receiving a user selection of a service, a menu location, or a content list; and directing the second display application to the selected service, menu location, or content list, respectively; receiving a user selection of the service, menu location, or content list, respectively, as an item to be added to a cross-service content list, the cross-service content list associated with a shortcut; causing the shortcut to be stored; and causing the shortcut to be displayed within the second display application.

Advantages of certain embodiments of the invention may include one or more of the following. Systems and methods according to the principles described here provide a global solution for content management, and in particular allow easy access to services and content lists by the creation and use of shortcuts to such items. The systems and methods allow a user to more quickly access the desired services and content lists, even on a new content playback device, because the same will have access to the user account immediately upon registration with a management server infrastructure.

Other advantages will be apparent from the description that follows, including the figures and claims.

### BRIEF DESCRIPTION OF THE DRAWINGS

Like reference numerals denote like elements throughout.

FIG. 1 is a block diagram of an exemplary system in accordance with one aspect of the present principles.

FIG. 2 is a sequence diagram illustrating a system and method according to another aspect of the present principles.

FIG. 3 is a flowchart illustrating an exemplary method according to a further aspect of the present principles, showing steps particularly appropriate for the creation of shortcuts to services.

FIG. 4 is a flowchart illustrating an exemplary method according to yet another aspect of the present principles, showing steps particularly appropriate for the creation of shortcuts to content lists.

FIG. 5 is a flowchart illustrating an exemplary method according to yet another aspect of the present principles, showing steps particularly appropriate for the creation of shortcuts to cross-service content lists.

FIG. 6 is a block diagram of an exemplary server in accordance with another aspect of the present principles.

FIG. 7 is a block diagram of an exemplary second display in accordance with another aspect of the present principles.

FIG. 8 illustrates an exemplary computing environment, e.g., that of the disclosed second display, proxy server, management server, or content server.

### DETAILED DESCRIPTION

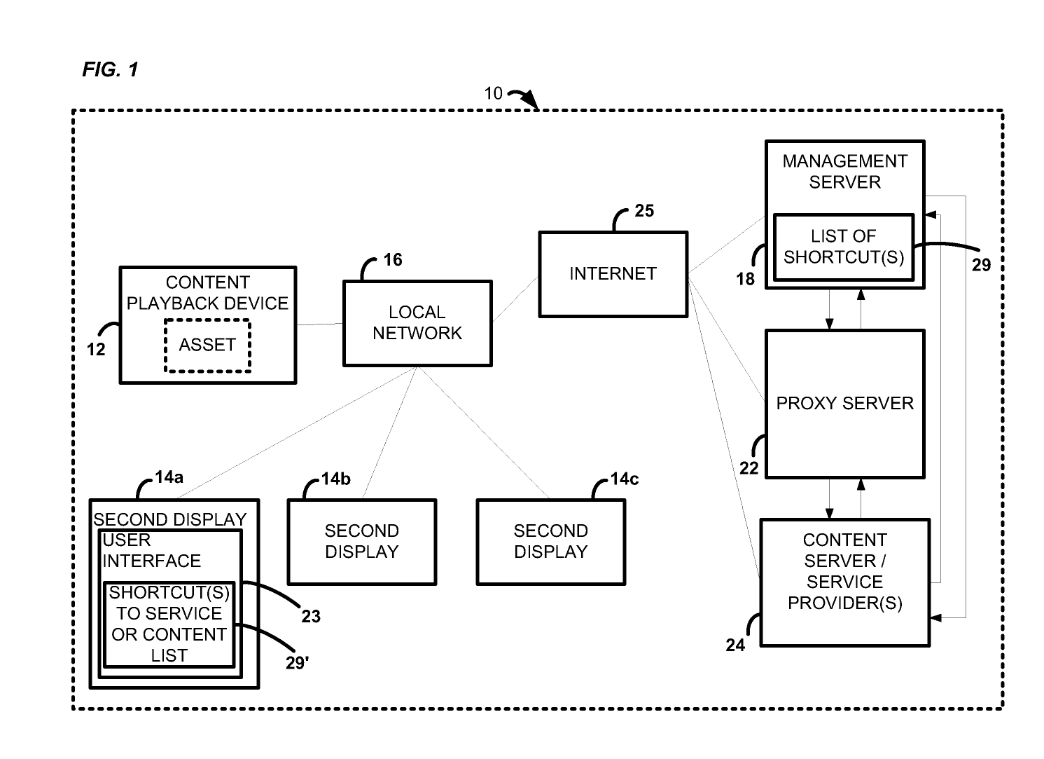

Referring initially to FIG. 1, a system 10 is shown including a content playback device 12 coupled to a local network 16, which may be wired, wireless, or a combination of both. Also coupled to the local network 16 are one or more second displays 14a-14c, an exemplary one of which is termed herein second display 14i. A number of servers may be accessed by the content playback device 12 and the second display 14i through the local network 16 and the internet 25, including a management server 18, a proxy server 22, and one or more content servers 24 corresponding to service providers (only one is shown in FIG. 1).

The second display 14a includes a user interface 23 for a second display application which when launched may in turn control in a number of aspects of service selection and content playback. In one aspect, according to the principles described here, the user interface may display a shortcut 29′, the shortcut being an activatable link to a service, a menu location, a content list, and may even include these items across various services accessible to the second display. The shortcut 29′, or list of such shortcuts, may correspond to a list 29 of shortcuts stored on the management server 18. Different ways in which the shortcuts may be generated, stored, updated, maintained, and used are described below.

Using the system 10 of FIG. 1, a user of the second display 14a is provided with a convenient way to access services or content lists. In this way, the user is saved the inconvenience of having to navigate through a large list of services, find a service, and arrange for access of the same. Moreover, the convenient and flexible user interface 23 of the second display 14a may then be leveraged to choose and navigate through the service to select content for playback on the content playback device 12.

Details of individual components are now described.

The content playback device 12 may be, e.g., an IPTV, a digital TV, a digital sound system, a digital entertainment system, a digital video recorder, a video disc player, a combination of these, or any number of other electronic devices addressable by a second display or other control on the local network 16. For the sake of simplicity, in this specification, the content playback device 12 will generally be exemplified by an IPTV, in which case the same will typically include a processor that controls a visual display and an audio renderer such as a sound processor and one or more speakers. The processor may access one or more computer-readable storage media such as but not limited to RAM-based storage, e.g., a chip implementing dynamic random access memory (DRAM), flash memory, cloud-based storage, or disk-based storage. Software code implementing present logic executable by the content playback device 12 may also be stored on one or more of the memories disclosed below to undertake present principles. The processor can receive user input signals from various input devices including a remote control device, a point-and-click device such as a mouse, a keypad, etc. A TV tuner may be provided in some implementations, particularly when the content playback device 12 is embodied by an IPTV, to receive TV signals from a source such as a set-top box, satellite receiver, cable head end, terrestrial TV signal antenna, etc. Signals from the tuner are then sent to the processor for presentation on the display and sound system. A network interface such as a wired or wireless modem communicates with the processor to provide connectivity to the Internet through the local network 16. It will be understood that communications between the content playback device 12 and the internet 25, or between the second display 14i and the internet, may also take place through means besides the local network 16. For example, the second display 14i may communicate with the content playback device 12 through a separate mobile network.

The one or more second displays 14a-14c each bear a processor and components necessary to operate an application for, e.g., service provider and content selection, as well as for display of a recently-accessed list of services. In particular, the processor in the second display may access one or more computer-readable storage media such as but not limited to RAM-based storage, e.g., a chip implementing dynamic random access memory (DRAM), flash memory, or disk-based storage. Software code implementing present logic executable by the second display may also be stored on one of the memories disclosed below to undertake present principles. Further, the second display 14i can receive user input signals from various input devices including a point-and-click device such as a mouse, a keypad, a touchscreen, a remote control, etc. The second display 14i may also receive user commands via the internet, such as via a remote control. For example, in some cases, remote data entry may be performed, or a command may be triggered, on a second display from a remote location via the internet. A network interface such as a wired or wireless modem communicates with the processor to provide connectivity to the local network and to wide area networks such as the Internet as noted above.

The servers 18, 22, and 24 have respective processors accessing respective non-transitory computer-readable storage media which may be, without limitation, disk-based and/or solid state storage. The servers communicate with a wide area network such as the Internet via respective network interfaces. The proxy server 22 may in some cases be combined with the management server 18, although in many cases it may be preferable to separate the servers to better accommodate server load. The servers may mutually communicate via the internet 25. In some implementations, the servers may be located on the same local network, in which case they may communicate with each other through the local network without accessing the internet. For example, in one exemplary implementation, the management server 18 and the proxy server 22 may be disposed in the same data center, so communications between the two may stay within the data center.

While an exemplary method of the system is described below, certain method steps especially pertinent to certain arrangements of the second display will be described here.

Responsive to the second display 14i sending a request to the proxy server 22 for an executable utility, the proxy server 22 returns the utility to each second display 14i. Running the utility causes the initialization of an application. The implementation discussed here includes a web application, but it will be understood that other types of applications may also be employed.

The second display 14i, executing the web application, prompts a user to input to each second display 14i login information. The login information may be common or may differ between second displays. The proxy server 22, responsive to reception of correct login information from the content playback device 12, returns the local IP address of the content playback device 12 to the second display 14i, because the same has previously been registered to a user account in which such information is maintained. The proxy server 22 may also return an external IP address. In this way, communications may be allowed from outside the local network, e.g., by a second display to a content playback device.

The proxy server 22 may also return a list of content playback devices on the local network, responsive to which the second display 14i may select one for content playback. In turn, each second display 14i uses the local content playback device address to access the content playback device 12 directly to request information about the content playback device 12, which information is returned from the content playback device 12 to the second display 14i such that the local address of the content playback device 12 need not be globally addressable. Each second display 14i may also select content for playback on different content playback devices. The second display 14i sends the information about the content playback device 12 to the proxy server 22, requesting a list of services available to the content playback device 12 from one or more service providers. The services may be dependent on the device characteristics of the content playback device 12 chosen. For example, if the chosen content playback device 12 is an IPTV, video services may be returned. If the chosen content playback device 12 is an audio system, audio services may be returned.

The proxy server 22 relays the request for a list of services to the management server 18, which returns the list to the proxy server 22, with the proxy server 22 in turn sending the list to the second display 14i for presentation of information on the second display 14i. Responsive to a user selection of an item on the list, which may include user selection of a short cut to a service or content list, the second display 14i sends a request for a software asset corresponding to the selected asset to the proxy server 22. The proxy server 22 requests a service login of the content server 24 providing the content, and the content server 24 provides to the proxy server 22 a list of assets, categories, or services, and the proxy server 22 relays the list to the second display 14i, which is presented on the second display 14i so that the user can navigate to enter a selection. Responsive to the selection, the second display 14i sends a command to the content playback device 12 to access and play back the selection.

The command to play the local asset may be in a number of forms. The second display 14i may communicate to the proxy server 22 the request on behalf of the content playback device 12, and this request may be via the local network or via other means. Alternatively, the second display 14i may transmit a request to the content playback device 12 that it itself formulates the request, and this transmission may be by way of the local network, the internet generally, or via other means such as other wired or wireless transmission schemes, including via USB, IR, Bluetooth®, or any other schemes. If the second display 14i is configured to address the content playback device 12 at a non-local level, e.g., at the server level, then the second display 14i may be physically located virtually anywhere and still be able to queue content or to command the content playback device 12 to play content. In this case, however, server load would increase over the case where the second display and content playback device communicated directly or over a local network.

Certain method steps of an arrangement of the content playback device are described here. Using a network interface, the content playback device 12 can communicate with a management server 18 on the internet and with one or more content servers 24, also on the internet and communicating with the management server 18. The management server 18 receives and stores a local IP address of the content playback device 12. The content playback device 12 communicates with the management server 18 to arrange for assets from the content server 24, operated by a service provider, to be played back on the content playback device 12. In more detail, in one embodiment, the content playback device 12 sends login information to the management server 18 which returns to the content playback device 12 a user token that must subsequently be presented by the content playback device 12 to the content server 24 to obtain content from the content server 24.

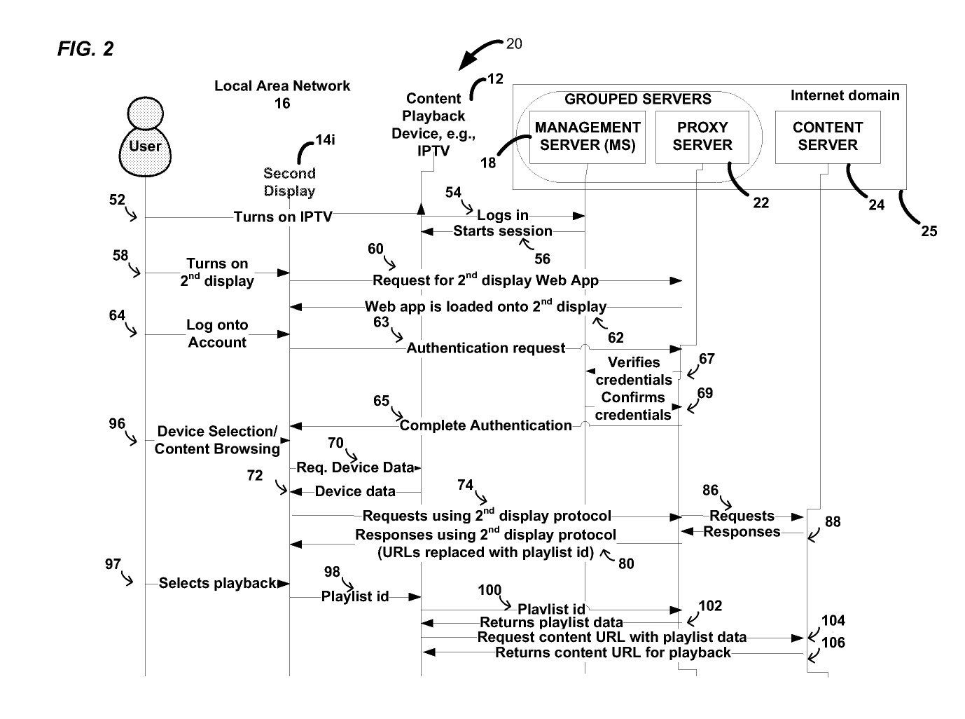

FIG. 2 is a sequence diagram illustrating an exemplary implementation of a method for enabling a user to employ a second display to browse content playback devices, service providers, and assets and select the same for playback by a content playback device. FIG. 2 assumes that the user has already created an account with a management server and has affiliated one or more content playback devices with that account.

At state 52, a user turns on the content playback device 12. At state 54 the content playback device sends login information including, e.g., username and password, to the management server 18, which at state 56 returns to the content playback device a user token that may subsequently be presented by the content playback device to a content server 24 to obtain content from that server. The management server 18 in addition stores the local IP address of the content playback device 12.

At state 58, the user turns on the second display 14i and instantiates a web browser session in which control may be exercised over the content playback device. Other types of sessions may also be employed as has been noted. A utility is executed on the second display 14i, at state 60, which sends a request to the proxy server 22, which returns in state 62 a web application, e.g., HTML with JavaScript, for the second display to execute for browsing services and assets. This application may make, e.g., asynchronous JavaScript and XML calls to the proxy server 22 and to the content playback device 12 to obtain information to control the content playback device 12.

At state 64, using the JavaScript received from the proxy server 22, the second display 14i prompts the user to input to the second display 14i the account login information, including, e.g., the same username and password that the content playback device provided to the management server 18 in state 54 during device registration. Of course, the account login information may differ as well. The user may be prompted to cache login information as well. It will be appreciated that the servers 18, 22, and 24 communicate necessary account information between them as needed to realize the principles described here.

The proxy server 22 responds to a correct user name and password from the second display 14i in an authentication request state 63. The proxy server 22 verifies the user name and password with the management server 18 (states 67 and 69), creates and transmits a session token to the second display, obtains information about content playback devices affiliated with the user account, and completes the authentication in state 65. The proxy server 22 may return to each second display the information about all content playback devices 12 that are affiliated with the user account associated with the user name and password, including their local IP addresses which were stored by the management server 18 after login at 54 (and subsequently provided to the proxy server 22). In more detail, the proxy server 22 sends a token to the second display 14i, the token associated with a content playback device, and this token is communicated in future transactions between the second display and the proxy server, so that the proxy server 22 knows what content playback device the asset is intended for. Each user with each second display may then choose a content playback device and browse the services and content options (or select a shortcut to a service, menu location, or content list) available through the services in state 96 and subsequent steps.

The second display 14i, using the local IP address returned as noted above, accesses the content playback device directly, in the sense of communicating through the local network. To select a particular content playback device, the second display 14i requests information about the content playback device 12 at state 70, including language information, digital rights management (DRM) information, etc., as desired, which information is returned from the content playback device to the second display 14i at state 72. Since the second display 14i knows the IP address of the content playback device 12 and consequently communicates directly with the content playback device 12, the second display 14i communicates using a local web address of the content playback device 12 that need not be globally addressable, and may so communicate as long as the second display 14i and content playback device 12 are on the same local network.

Each second display 14i may send the client information received at state 72 to the proxy server 22, requesting a list of services available to the content playback device 12, or that the content playback device 12 is entitled to, from one or more of the content servers 24. The proxy server 22 relays the request to the management server 18, which returns the requested service list to the proxy server 22. The proxy server 22 in turn sends the services list to the second display for presentation of available services on the second display. Each user browses the services and their content on the second display just as though it were the actual content playback device.

A user can input, using, e.g., a second display input device, a selection of a service on the list that was returned to the second display. Alternatively, a user may select a shortcut to a service, menu location, or content list. In response, the second display, at state 74, sends a request for the corresponding service to the proxy server 22 along with the service token that that second display may have received from the content server 24 via the management server 18.

Responsive to the request, the proxy server 22 requests a service login at state 86 of the content server 24 providing the selected service. At state 88, the content server 24 provides to the proxy server 22 a list of assets, categories or services, as the case may be, for the particular content server 24. If desired, the proxy server 22 may also request of the content server 24 a list of options, and the list may be returned in, e.g., extended markup language (XML) format to the proxy server 22 which relays the assets, categories, services, etc. available for selection to the second display at the state 80.

The content available for selection is presented on the second display so that the user can navigate (in state 97) the display to enter a selection. Responsive to the selection, the second display at state 98 sends a command to the content playback device 12 to play the selection, and in particular sends a playlist id or reference identifier indicating the selection. At state 100, the content playback device 12, using its authentication credentials, sends the playlist id or reference identifier to the proxy server 22, which returns the required playlist data in state 102. The content playback device 12 can then request the content URL with the playlist data in state 104, which may be responded to with a return of the content URL for playback of the asset on the content playback device 12 in state 106.

Variations of the system and method are now described.

If the content playback device were already playing content, the new content commanded to be played by the second display may be placed in a queue in the content playback device and played when the current content completes. In any case, once the content has been commanded to be played, the user may continue to browse the second display for other content, to play or add to the queue. Other users on the network may employ their own second displays to do the same.

The above description has been for the case where the proxy server 22 is employed to hide the content source, e.g., a content URL, from the second display 14i. That is, the proxy server 22 provides an API for the second display to use so that the content and/or content URL cannot be accessed directly. In this way, the details of the management server transactions to access the services remain desiredly unknown. In many cases, the second display 14i may have stored thereon little or no details about the content playback device 12. In some cases, however, the URL may be directly provided from the proxy server 22 or the proxy server 22 may even be bypassed, e.g., in cases where the asset is intended for free distribution, e.g., movie or game trailers or the like. Similarly, while the above description has focused on asset playback on content playback device 12, certain assets, e.g., those which are intended for free distribution, may be played back on the second display 14i itself, if the same has been appropriately configured.

In the case where multiple second displays request content to be played at or near the same time, a simple rule such as the first-in-time may prevail. Alternatively, a priority scheme may be configured, such that certain second displays take precedence over other second displays. Alternatively, a plurality of user profiles may be employed, and precedence may be based on the identity of specific users.

The control device may command the content playback device to play content by sending, to the content playback device over the local network, commands coded as if they were sent from an infrared remote control, e.g., the commands may be in the Sony Infrared Remote Control System (SIRCS) protocol.

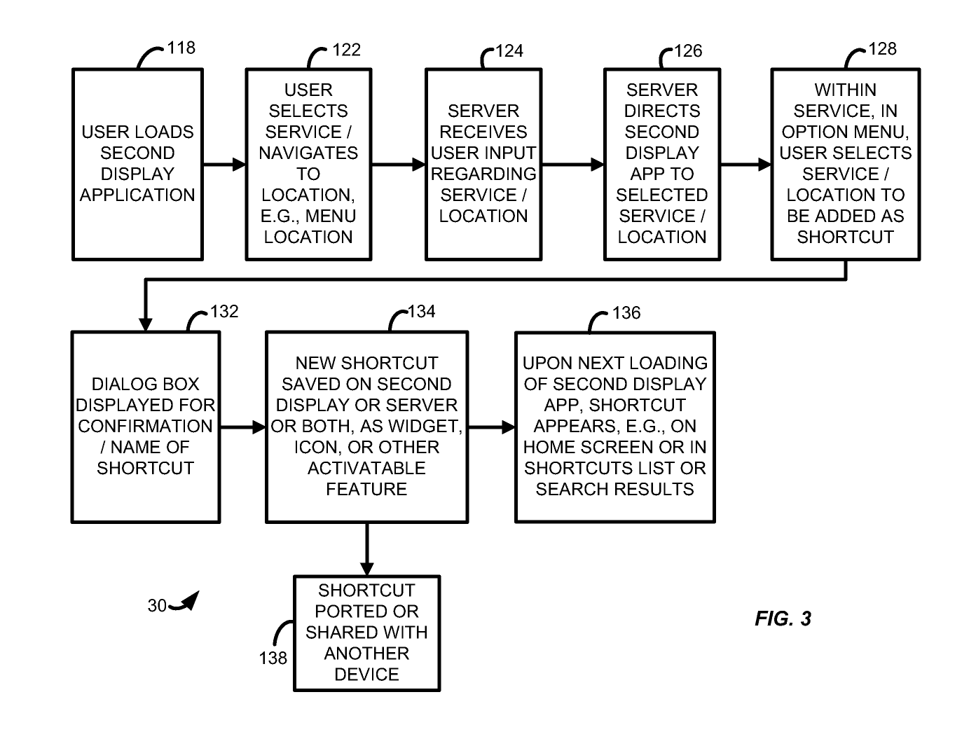

FIG. 3 is a flowchart 30 of a method including steps for creating, maintaining, and using shortcuts to services, menu locations, or content lists. It will be understood that certain steps may occur that are not shown on FIG. 3. For example, a step may be included of an establishment of a user account session between a second display and a server, e.g., via a second display application. The second display application may be a web application, a native application, or any other application by which a second display may communicate with the server. The session may be associated with a user account, and the user generally enters logon credentials such as a username and password for access. Other variations will also be understood. For example, the server may be a management server, a proxy server, or the like.

A first step shown in FIG. 3 is that a user loads a second display application within their second display (step 118). In this step, the user instantiates the second display application within their second display. A next step is that the user selects a service using the second display application (step 122). There are several ways in which a service may be selected. For example, the user may choose the service out of a list or array of services. Alternatively, the user may select the service out of a set of search results found in, e.g., a keyword search. Besides services, the user may also have navigated to a menu location within the second display application or within a server application. For example, the user may have navigated to a parental controls menu, the same being several levels deep within the menu system. A next step is that the server receives user input regarding the service or (optionally) the menu location (step 124). The server then directs the second display application to the selected service or (optionally) to the selected menu location (step 126) if the same has not already been navigated to. Where the menu location is within the second display application, step 126 may not be performed. A next step is to, within the service, and in particular within an option menu, the user selects a service to be added as a shortcut (step 128). In the case of a menu location, this step is analogous, but need not be performed within a service. A dialog box may then be displayed for confirmation that the user wishes to create a shortcut (step 132). The user may also name the shortcut. By naming the shortcut, the shortcut may be found in a search within the second display application. In this connection, it is noted that one such global search tool for a second display application is disclosed in co-pending [IP:3453] U.S. Nonprovisional patent application Ser. No. 13/077,695, filed Mar. 31, 2011, entitled “Method and Apparatus for Searching Over a Network”, owned by the assignee of the present invention and herein incorporated by reference in its entirety.

The new shortcut is then saved on the second display, or server, or both (step 134). The shortcut may be saved in any number of ways, including as a widget, an icon, or other activatable feature. In many cases the shortcut will then appear on a desktop or homepage of the second display application, although the same may appear in any location within the application, as a shortcut that appears in the same location on every page of the second display application, or as part of a list of shortcuts.

Consequently, upon the next loading of the second display application, the shortcut appears (step 136). The same may appear not only on a page within the application, but also in search results, shortcut lists, or the like. Moreover, the shortcut may be copied to, ported, or shared with another device (step 138). For example, if a user has the shortcut on their mobile phone, they may port it to a laptop, or to another user's mobile phone, e.g., via Bluetooth®, infrared, a wired connection, or the like.

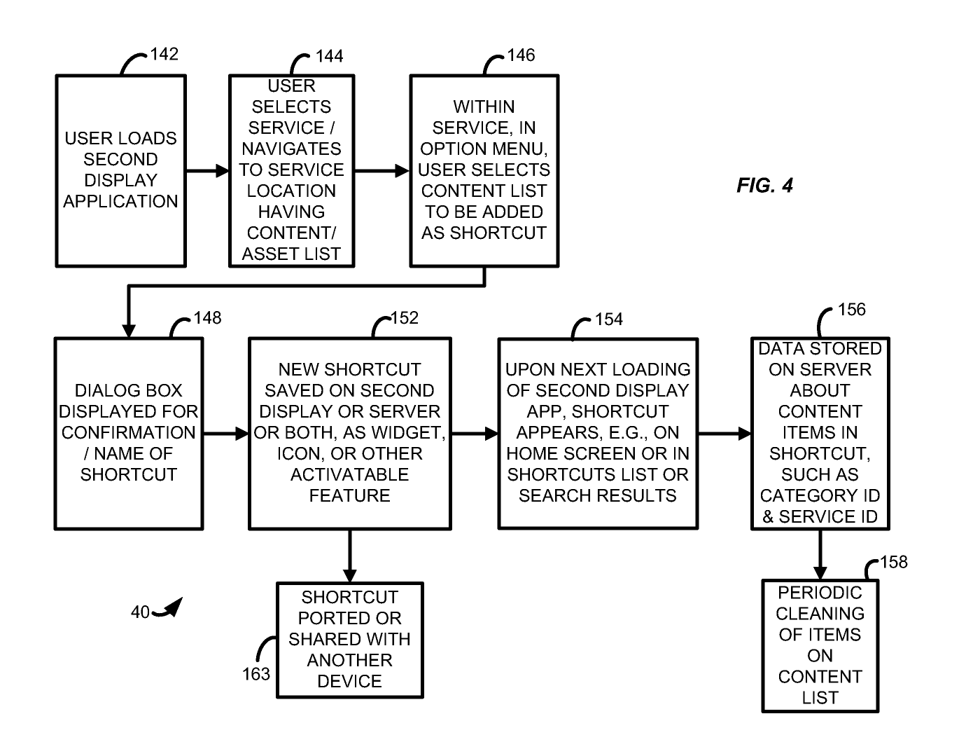

FIG. 4 is a flowchart 40 for a method of creating, maintaining, and using a shortcut to a content list. Certain similarities will be seen between the method of FIG. 4 and that of FIG. 3, particularly with regard to the establishment of a user account, and these details are not repeated here.

First steps in FIG. 4 includes that a user loads a second display application (step 142) and that a user selects a service or navigates to a service location having a content or asset list (step 144). As noted, the term “content list” can refer to a category list or any other sort of list of content items or other assets, whether created by the user or created by the system, either automatically or on the basis of some user-specified criterion. In many cases, the content list will correspond to a category of assets within a service. However, many other possibilities will also be seen by one of ordinary skill in the art given this teaching.

A next step is that, within the service, e.g., within an option menu, the user selects a content list to be added as a shortcut (step 146). In this case, a user has decided that a selected content list is one that they desire to see again, and thus the shortcut creates a convenient way to re-access the content list. As above, a dialog box may be provided for confirmation of the shortcut creation, and the user may name the shortcut in a related step (step 148). The new shortcut may then be saved on the second display, or on the server, or both, as a widget, icon, or other activatable feature (step 152). As above, the shortcut may be ported or shared with another device (step 162). In any case, upon the next loading of the second display application, the shortcut appears, such as on a home screen, in a shortcut list, or is discoverable using a searching facility (step 154).

In this connection it is noted that for flowcharts 30 and 40, as well as flowchart 50 described below, some second display applications can immediately start accessing a shortcut immediate the after its creation, i.e., there is no need for a re-instantiation of the second display application. Both situations are intended to be encompassed in the instant systems and methods.

For convenience, data may be stored on the server about content items in the shortcut, such as category ID and service ID (step 156). A clean up tool may be employed to perform periodic cleanups of the list (step 158). Such cleaning may ensure that the content or asset list still exists, as well as may ensure the integrity of the items in the list, as service providers may remove such lists, or individual assets within such lists, at any time. In this regard it is noted that keeping track of the service ID may be useful, as the service ID in many cases does not change, even though a URL associated with a given asset URL may expire in a certain time frame due to the content item being classified as a rental or having other content time restrictions placed thereon.

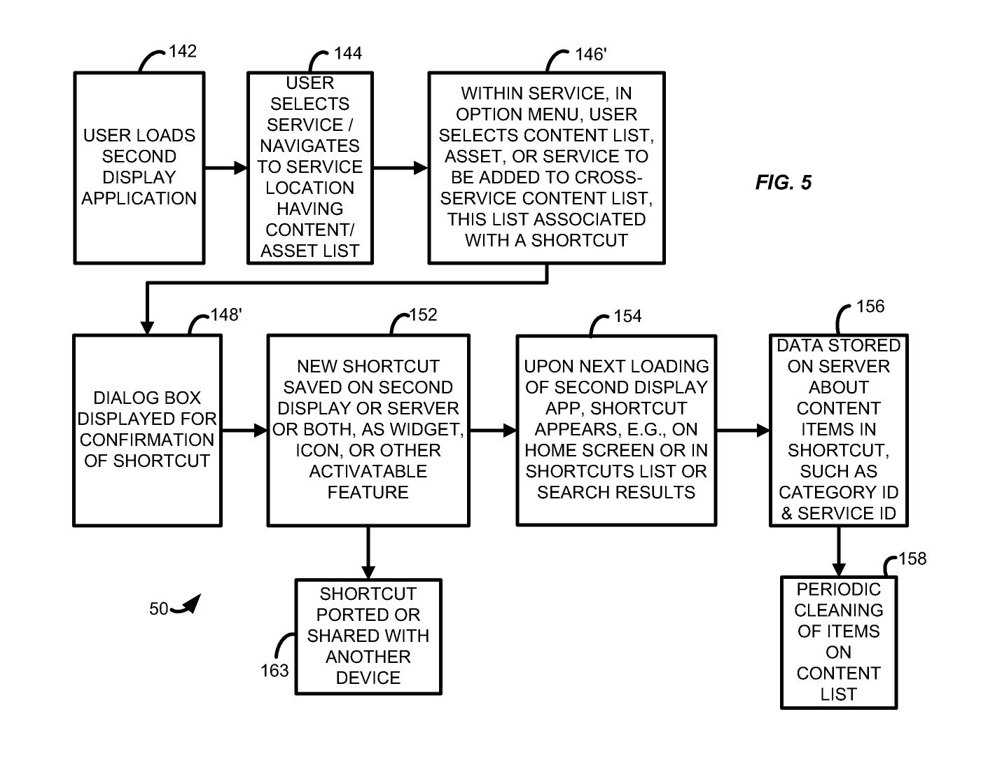

FIG. 5 is a flowchart 50 of a related method, where shortcuts are created not just to a desired service or content list but to a content list that includes multiple services or assets from multiple services. Such a content list is termed herein a cross-service content list. Many of the steps are the same as in FIG. 4, and their explanation is not repeated here. A first unique step of FIG. 5 is that, following step 144 as described, within an option menu of service, the user selects a content list, an asset, or a service to be added to a cross-service content list. In turn, the cross-service content list is associated with a shortcut (step 146′). As the user navigates to another services or discovers other content lists to which re-access is desired, the user may add such services or content lists to the cross-service content list. By then clicking on the shortcut created in step 152, the variety of services and content lists may be accessed.

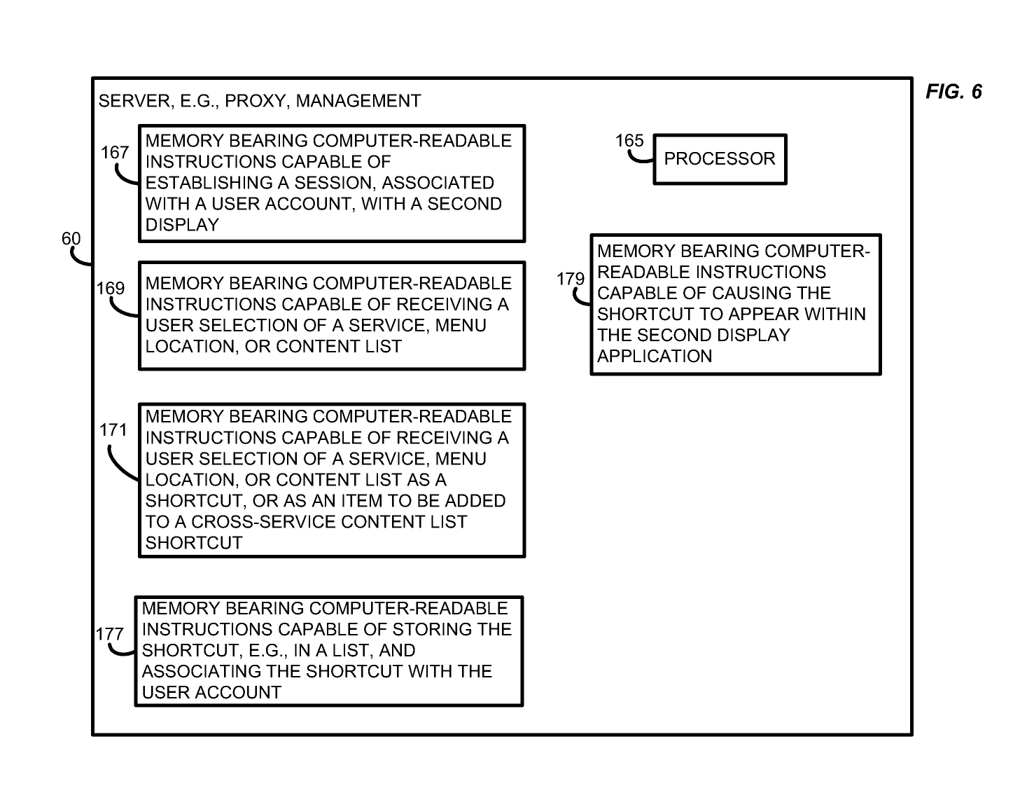

Referring to FIG. 6, an implementation of a server 60 that may perform methods according to the disclosed principles is illustrated. In this implementation, the server includes various memory locations bearing computer-readable instructions capable of performing various steps. The server may be, e.g., a proxy server, a management server, or any other sort of server as described above. The server 60 includes a processor 165 and memory 167 bearing computer-readable instructions capable of establishing a session, associated with the user account, with a second display. The server 60 may further include memory 169 bearing computer-readable instructions capable of receiving user selection of a service, menu location or content list.

The server 60 further includes memory 171 bearing computer-readable instructions capable of receiving a user selection of a service, menu location, or content list as a shortcut, or as an item to be added to a cross-service content list shortcut. Next, the server 60 includes memory 177 bearing computer-readable instructions capable of storing the shortcut, e.g., in a list, and associating the shortcut with the user account. Finally, the server 60 includes memory 179 bearing computer-readable instructions capable of causing the shortcut to appear within the second display application. This memory may cause the shortcut to appear on a desktop or a homepage of the second display application, as well as deeper within the second display application, such as in a list of shortcuts or as discovered in a search.

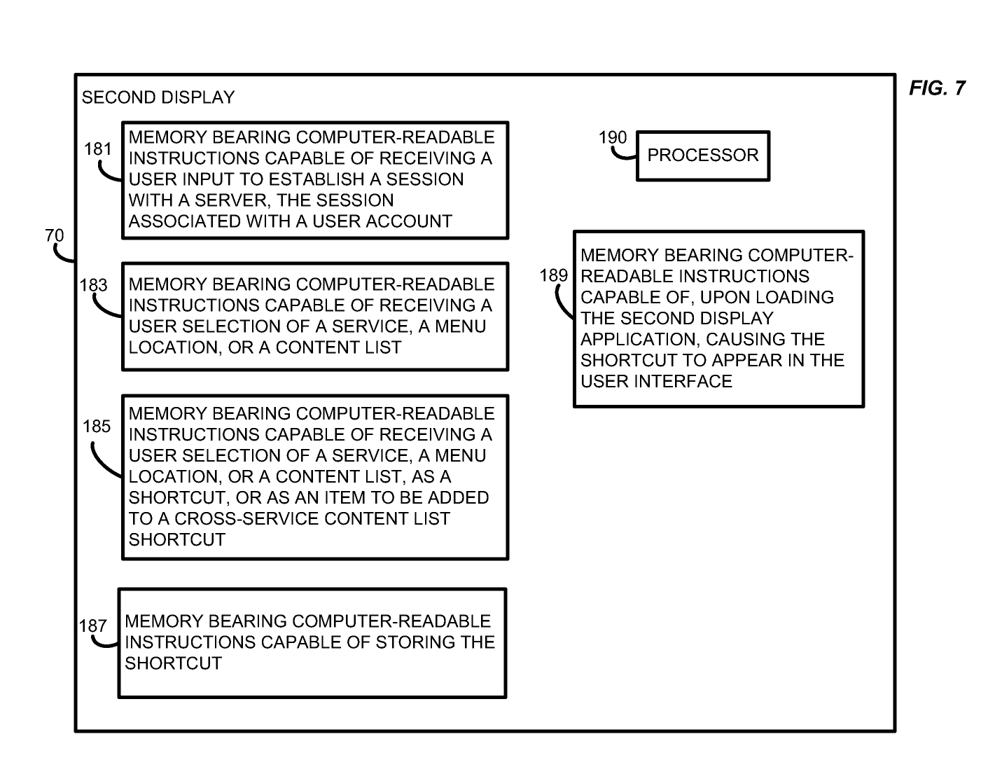

Referring to FIG. 7, an implementation of a second display 70 that may perform methods according to the disclosed principles is illustrated. In this implementation, as in FIG. 6, the second display includes various memory locations bearing computer-readable instructions capable of performing various steps. The second display may be, e.g., any of the types of computing devices as described above. The second display 70 includes a processor 190 and memory 181 bearing computer-readable instructions capable of receiving a user input to establish a session with a server, the session associated with a user account. The second display 70 may further include memory 183 bearing computer-readable instructions capable of receiving a user selection of a service, a menu location, or a content list. The services are generally from a service provider, and may be grouped as a group of services accessible through a management server infrastructure. The second display 70 may further include memory 185 bearing computer-readable instructions capable of receiving a user selection of a service, a menu location, or content list, as a shortcut, or as an item to be added to a cross-service content list shortcut.

The second display 70 further includes memory 187 bearing readable instructions capable of storing the shortcut. The memory 187 is optional as the shortcut may be stored on the server as well. Finally, the second display 70 may include memory 189 bearing computer-readable instructions capable of, upon loading the second display application, causing the shortcut to appear. The same may be caused to appear in various forms, such as an icon, widget, or other activatable feature, such as on a desktop or a homepage of the second display application, in a list of shortcuts, or as discovered in a search. Other memories may also be included, such as those that allow for a prompting of the user to automatically return to a highest ranked shortcut, or the like.

Other memories will also be understood, although these are not shown in FIGS. 6 and 7. In an alternative implementation, these memories may be implemented as modules, either in software, hardware, or various forms of firmware. For example, a session module may be employed to establish a user account session between the server and the second display. A database module may be employed to store the shortcuts. Communications modules may be employed to provide data-transfer corresponding to services. Other modules will also be understood.

Systems and methods have been disclosed that allow improvement of the user experience of the IPTV without adding to the hardware costs of the unit. As disclosed above, users may employ the system and method to create and utilize shortcuts to desired services, menu locations, and content lists, thereby allowing convenient access to the same.

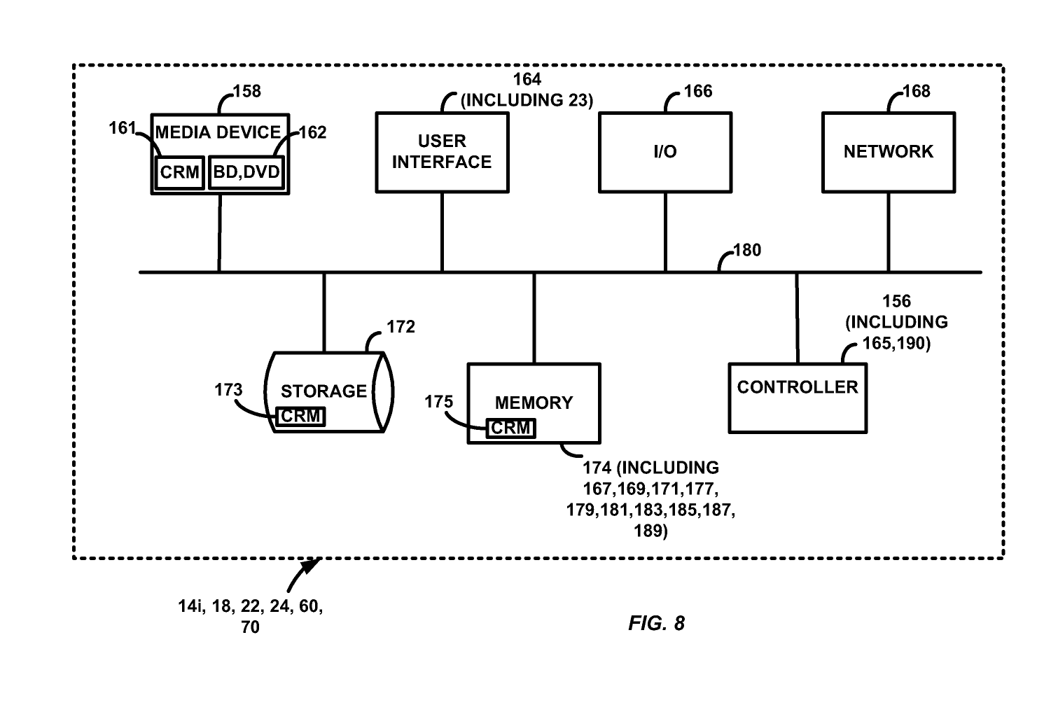

One implementation includes one or more programmable processors and corresponding computing system components to store and execute computer instructions, such as to execute the code that provides the second display 14 or various server functionality, e.g., that of the proxy server 22, management server 18, and content server 24. Referring to FIG. 8, a representation of an exemplary computing environment for a second display or for any of the servers is illustrated.

The computing environment includes a controller 156, a memory 174, storage 172, a media device 158, a user interface 164, an input/output (I/O) interface 166, and a network interface 168. The components are interconnected by a common bus 180. Alternatively, different connection configurations can be used, such as a star pattern with the controller at the center.

The controller 156 includes a programmable processor and controls the operation of the second display and servers and their components. The controller 156 loads instructions from the memory 174 or an embedded controller memory (not shown) and executes these instructions to control the system. In its execution, the controller 156 may provide the second display control of a content playback device system as, in part, a software system. Alternatively, this service can be implemented as separate modular components in the controller 156 or the second display.

Memory 174, which may include non-transitory computer-readable memory 175, stores data temporarily for use by the other components of the second display and servers, and the same may include memories 167, 169, 171, 177, 179, 181, 183, 185, 187, and 189 as discussed above. In one implementation, memory 174 is implemented as RAM. In other implementations, memory 174 also includes long-term or permanent memory, such as flash memory and/or ROM.

Storage 172, which may include non-transitory computer-readable memory 173, stores data temporarily or long-term for use by other components of the second display and servers, such as for storing data used by the system. In one implementation, storage 172 is a hard disc drive or a solid state drive.

The media device 158, which may include non-transitory computer-readable memory 161, receives removable media and reads and/or writes data to the removable media. In one implementation, the media device 158 is an optical disc drive or disc burner, e.g., a writable Blu-ray® disc drive 162.

The user interface 164 includes components for accepting user input from the user of the second display, and presenting information to the user. In one implementation, the user interface 164 includes a keyboard, a mouse, audio speakers, and a display. For example, the controller 156 uses input from the user to adjust the operation of the second display.

The I/O interface 166 includes one or more I/O ports to connect to corresponding I/O devices, such as external storage or supplemental devices, e.g., a printer or a PDA. In one implementation, the ports of the I/O interface 166 include ports such as: USB ports, PCMCIA ports, serial ports, and/or parallel ports. In another implementation, the I/O interface 166 includes a wireless interface for wireless communication with external devices. These I/O interfaces may be employed to connect to one or more content playback devices.

The network interface 168 allows connections with the local network and optionally with content playback device 12 and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, infrared, or the like.

The second display and servers may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and within the scope of the present invention. For example, while media content services have been focused on, the user may also browse, and store as shortcuts, services for other types of business or consumer transactions, such as video rentals, home shopping sites, or the like on the second display. In addition, while menu locations within the second display applications have been discussed, users may also store shortcuts to menu locations within the management server infrastructure. Shortcuts may be ranked by the user, so that the most desired shortcuts appear at a top of a list of shortcuts. Cross-service shortcuts may include links to menu locations or other such locations.

While the system and method have described implementations in which content playback devices have been selected by a user before browsing, numerous other variations are possible. For example, a cache or cookie or other information may be employed to store information about content playback devices, so that no user choice is necessary. In another example, samples of assets, e.g., movie trailers, may be obtained from content service providers, and these samples may be browsed freely without a user selection of a content playback device for playback even including playback on the second display if supported. In another variation, a profile system may be employed that communicates content playback device information upon start-up according to a profile; e.g., a given content playback device may always be associated with and may authenticate itself with a given service provider. In this sense, a content playback device is still being chosen, but the choice does not require an affirmative step by the user. Use of any of these alternatives, or others, ensures that the content consumption of each content playback device is tracked. It further allows, as described, the proxy server to filter out content that the content playback device is incapable of playing. Even where browsing requires no device choice at all, e.g., browsing shopping sites, some level of customization may occur, e.g., by consideration of the origination location of the visiting second display's IP address.

In addition, the above description was primarily directed to implementations in which the local IP address of the second display was retrieved and stored on the server. However, other ways of discovering the second display are also possible. For example, device discovery is also possible using a broadcast method within the local network. Compatible devices that recognize the broadcast message will respond with their necessary credentials and information to indicate their compliance with the application for the second display. In many cases, broadcasting methods are primarily directed to native applications, not web applications; however, a broadcasting library may be employed to allow the implementation even within a web application.

While the above description has focused on implementations where a second display is coupled to a content playback device through a local network or over the internet, it will be understood that the same will apply to any method by which the two may communicate, including 3G, 4G, and other such schemes.

Accordingly, the present invention is not limited to only those implementations described above.

1. A method of creating a shortcut to a service or content list, comprising:
i. in a second display application, receiving a user input to establish a session with a server, the session associated with a user account;
ii. receiving a user selection of a service, a menu location, or a content list; and
iii. receiving a user selection of the service, menu location, or content list, respectively, as a shortcut,
iv. such that upon a loading of the second display application, the shortcut appears within the application.

2. The method of claim 1, further comprising creating a shortcut within the second display application to the selected service, menu location, or content list.

3. The method of claim 1, wherein the second display application is a web application.

4. The method of claim 1, wherein the content list is a category within a service.

5. The method of claim 1, wherein the shortcut appears as a widget or icon or activatable feature on a page of the second display application.

6. The method of claim 1, wherein the shortcut appears in a list of shortcuts.

7. The method of claim 1, wherein the shortcut is associated with a shortcut name, and wherein the name of the shortcut is discoverable in a search field within the second display application.

8. The method of claim 1, wherein the user selection is of a content list, and further comprising storing a category identification or service identification of the content list.

9. The method of claim 1, wherein the user selection is of a content list, and further comprising updating the content list, to remove content items that point to content that is no longer available.

10. The method of claim 1, wherein the user selection is of a content list, and wherein the content list is determined by a service or by a user.

11. The method of claim 1, wherein the user selection is of a menu location, and wherein the menu location corresponds to a utility or administrative function.

12. The method of claim 1, wherein the receiving a user selection of a service, a menu location, or a content list, includes receiving search results from a search function within the second display application, and wherein the search results include services, menu locations, content items, or content lists.

13. The method of claim 1, further comprising creating a copy of the shortcut on another computing device.

14. A non-transitory computer-readable medium, comprising instructions for causing a computing device to perform the method of claim 1.

15. A method of creating a shortcut to a service or content list, comprising:
i. in a second display application, receiving user input to establish a session with a server, the session associated with a user account;
ii. receiving a user selection of a service, a menu location, or a content list; and
iii. receiving user selection of the service, menu location, or content list, respectively, as an item to be added to a cross-service content list, the cross-service content list associated with a shortcut,
iv. such that upon the loading of the second display application, the shortcut appears within the second display application.

16. A method of creating a shortcut to a service or content list, comprising:
i. receiving a user input from a second display application to establish a session, the session associated with a user account;
ii. receiving a user selection of a service, a menu location, or a content list;
iii. directing the second display application to the selected service, menu location, or content list, respectively;
iv. receiving a user selection of the service, menu location, or content list, respectively, as a shortcut;
v. causing the shortcut to be stored; and
vi. causing the shortcut to be displayed within the second display application.

17. The method of claim 16, wherein the causing the shortcut to be stored includes causing the shortcut to be stored within the server or within the second display application.

18. The method of claim 16, wherein the user selection is of a content list, and further comprising storing a category identification or service identification corresponding to the content list.

19. The method of claim 16, wherein the user selection is of a content list, and further comprising updating the content list, to remove content items that point to content that is no longer available.

20. A non-transitory computer-readable medium, comprising instructions for causing a computing device to perform the method of claim 16.

21. A method of creating a shortcut to a service or content list, comprising:
i. receiving user input from a second display application to establish a session, the session associated with a user account;
ii. receiving a user selection of a service, a menu location, or a content list; and
iii. directing the second display application to the selected service, menu location, or content list, respectively;
iv. receiving a user selection of the service, menu location, or content list, respectively, as an item to be added to a cross-service content list, the cross-service content list associated with a shortcut;
v. causing the shortcut to be stored; and
vi. causing the shortcut to be displayed within the second display application.
